(19) United States
(12) Patent Application Publication
(10) Pub. No.: US 2018/0188033 A1
(43) Pub. Date: Jul. 5, 2018

(54) NAVIGATION METHOD AND DEVICE

(71) Applicant: Baidu Online Network Technology (Beijing) Co., Ltd., Beijing (CN)

(72) Inventors: Chen ZHAO, Beijing (CN); Zhongqin WU, Beijing (CN); Yingchao LI, Beijing (CN); Hui QIAO, Beijing (CN); Yongjie ZHANG, Beijing (CN)

(21) Appl. No.: 15/617,824

(22) Filed: Jun. 8, 2017

(30) Foreign Application Priority Data
Dec. 30, 2016 (CN) 201611259771.8

(51) Int. Cl. G01C 21/20; G06T 19/00; G06K 9/00; G06T 7/73; G06K 9/46; G01S 5/02

(52) U.S. Cl. CPC G01C 21/206; G06T 19/006; G06K 9/00671; G06T 7/73; G06T 2207/30204; G01S 5/0284; G06T 2207/30244; G06T 2207/10004; G06K 9/4671

(57) ABSTRACT

The present disclosure discloses a navigation method and apparatus. A specific implementation of the method comprises: sending an image captured by a terminal used by a user in an indoor environment to a server, the image comprising an identification object; receiving navigation information associated with a position of the user in the indoor environment returned from the server, the position being determined by the server based on a preset identification object matching the identification object and a position in the indoor environment corresponding to the preset identification object; and presenting at least a portion of the navigation information in the image by adopting an augmented reality mode. The navigation method and apparatus provided here achieves a comparatively accurate location of the position of the user in the indoor environment by the user photographing the image with the terminal only, enhancing the accuracy of the navigation and possessing a strong applicability.

### CROSS-REFERENCE TO RELATED APPLICATION

This application is related to and claims priority from Chinese Application No. 201611259771.8, filed on Dec. 30, 2016, entitled “Navigation Method and Apparatus” the entire disclosure of which is hereby incorporated by reference.

### TECHNICAL FIELD

The present disclosure relates to the field of computer, specifically to the field of navigation technology, and more specifically to a navigation method and apparatus.

### BACKGROUND

At present, the commonly used navigation mode in the indoor environment is: locating the user's position using locating modes such as a base station or WiFi, and displaying the navigation route between the user's position and the destination in the electronic map.

However, when navigating in the indoor environment by adopting the above navigation mode, on one hand, it is impossible to accurately locate the current position of the user due to factors such as the low positioning accuracy of the positioning mode itself, or blocking by the building, leading to a reduction of the navigation accuracy, and on the other hand, it is also impossible to present to the user a navigation route in the real environment, thus the navigation effect is relatively poor.

### SUMMARY

The present disclosure provides a navigation method and apparatus, in order to solve the technical problem mentioned in the foregoing Background section.

In a first aspect, the present disclosure provides a navigation method, the method comprising: sending an image captured by a terminal used by a user in an indoor environment to a server, the image comprising an identification object; receiving navigation information associated with a position of the user in the indoor environment returned from the server, the position being determined by the server based on a preset identification object matching the identification object and a position in the indoor environment corresponding to the preset identification object; and presenting at least a portion of the navigation information in the image by adopting an augmented reality mode.

In a second aspect, the present disclosure provides a navigation method, the method comprising: receiving an image captured by a terminal sent by the terminal used by a user in an indoor environment, the image comprising an identification object; determining a position of the user in the indoor environment, based on a preset identification object matching the identification object and a position in the indoor environment corresponding to the preset identification object; and sending navigation information associated with the position to the terminal used by the user, to present at least a portion of the navigation information in the image by adopting an augmented reality mode on the terminal used by the user.

In a third aspect, the present disclosure provides a navigation apparatus, the apparatus comprising: an image sending unit, configured to send an image captured by a terminal used by a user in an indoor environment to a server, the image comprising an identification object; a navigation information receiving unit, configured to receive navigation information associated with a position of the user in the indoor environment returned from the server, the position being determined by the server based on a preset identification object matching the identification object and a position in the indoor environment corresponding to the preset identification object; and a navigation information presenting unit, configured to present at least a portion of the navigation information in the image by adopting an augmented reality mode.

In a fourth aspect, the present disclosure provides a navigation apparatus, the apparatus comprising: an image receiving unit, configured to receive an image captured by a terminal sent by the terminal used by a user in an indoor environment, the image comprising an identification object; a position determining unit, configured to determine a position of the user in the indoor environment, based on a preset identification object matching the identification object and a position in the indoor environment corresponding to the preset identification object; and a navigation information sending unit, configured to send navigation information associated with the position to the terminal used by the user, to present at least a portion of the navigation information in the image by adopting an augmented reality mode on the terminal used by the user.

By sending an image captured by a terminal used by a user in an indoor environment to a server, the image including: an identification object; receiving navigation information associated with a position of the user in the indoor environment returned from the server, the position being determined by the server based on a preset identification object matching the identification object and a position in the indoor environment corresponding to the preset identification object; and presenting at least a portion of the navigation information in the image by adopting an augmented reality mode, the navigation method and apparatus provided by the present disclosure achieves a comparatively accurate location of the position of the user in the indoor environment by the user photographing the image with the terminal only, without relying on any specific equipments, thereby enhancing the accuracy of the navigation and possessing a strong applicability, and further, the navigation information associated with the position of the user in the indoor environment is presented in real environment, and the navigation effect is improved.

### BRIEF DESCRIPTION OF THE DRAWINGS

Other features, objectives and advantages of the present disclosure will become more apparent upon reading the detailed description to non-limiting embodiments with reference to the accompanying drawings, wherein:

FIG. 1 is an exemplary system architecture diagram of a navigation method or apparatus in which the present disclosure may be applied;

FIG. 2 is a flowchart of an embodiment of a navigation method according to the present disclosure;

FIG. 3 is a flowchart of another embodiment of the navigation method according to the present disclosure;

FIG. 4 is a schematic structural diagram of an embodiment of a navigation apparatus according to the present disclosure;

FIG. 5 is a schematic structural diagram of another embodiment of the navigation apparatus according to the present disclosure; and

FIG. 6 is a schematic structural diagram of a computer system adapted to implement a terminal device or server according to embodiments of the present disclosure.

### DETAILED DESCRIPTION OF EMBODIMENTS

The present disclosure will be further described below in detail in combination with the accompanying drawings and the embodiments. It should be appreciated that the specific embodiments described herein are merely used for explaining the relevant invention, rather than limiting the invention. In addition, it should be noted that, for the ease of description, only the parts related to the relevant invention are shown in the accompanying drawings.

It should be noted that the embodiments in the present disclosure and the features in the embodiments may be combined with each other on a non-conflict basis. The present disclosure will be described below in detail with reference to the accompanying drawings and in combination with the embodiments.

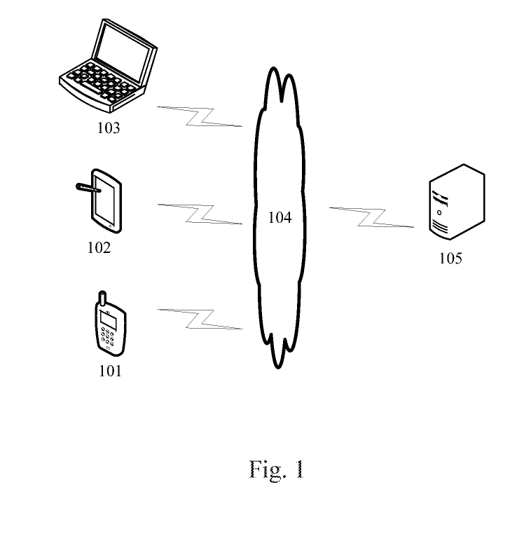

FIG. 1 shows an exemplary system architecture of an embodiment of a navigation method or apparatus in which the present disclosure may be applied.

As shown in FIG. 1, the system architecture may include terminal devices 101, 102, 103, a network 104 and a server 105. The network 104 serves as a medium providing a communication link between the terminal devices 101, 102, 103 and the server 105. The network 104 may include various types of connections, such as wired or wireless communication links, or optical fibers and the like.

The terminal devices 101, 102, 103 may be electronic devices with display screens supporting network communication, including but not limited to smart phones, tablet computers. The terminal devices 101, 102, 103 may be installed with various communication applications, such as an augmented reality application, instant messaging applications, etc.

The user who needs navigation in the indoor environment may use the terminal devices 101, 102, 103 to photograph and obtain an image including the identification object, and send the image including the identification object to the server 105. The server 105 may determine the location of the user of the terminal devices 101, 102, 103 in the current indoor environment based on the image sent from the terminal devices 101, 102, 103, and send the navigation information associated with the location of the user of the terminal devices 101, 102, 103 in the current indoor environment to the terminal devices 101, 102, 103. The terminal devices 101, 102, 103 may present the navigation information in the photographed image by adopting the augmented reality mode. The collecting-responsible staff may obtain an image including the preset identification object corresponding to the identification object in the preset area by using the terminal devices 101, 102, 103 and photographing in advance in the preset area in the indoor environment, and send the image including the preset identification object corresponding to the identification object in the preset area to the server 105.

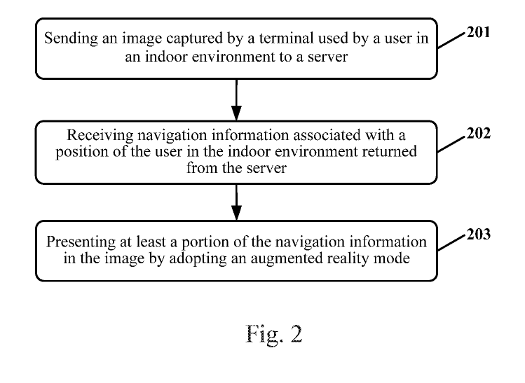

Referring to FIG. 2, a flow of an embodiment of the navigation method according to the present disclosure is shown. The navigation method provided by the embodiment of the present disclosure may be performed by a terminal such as the terminal devices 101, 102, 103 in FIG. 1, and accordingly, the navigation apparatus may be provided in a terminal such as the terminal devices 101, 102, 103 in FIG. 1. The method comprises the following steps:

Step 201, sending an image captured by a terminal used by a user in an indoor environment to a server.

For example, when the indoor environment is a mall, there are identifiers in the mall which may easily catch the user's attention in a visual sense. When the user needs navigation in the mall, the user may use the terminal camera to capture an image. When an identifier is contained in the viewfinder of the camera, the obtained captured image may contain an identification object corresponding to the identifier.

In some alternative implementations of the present embodiment, the identification object comprises at least one of the following: a sticker object, a poster object and a building identification object.

For example, when the indoor environment is a mall, the mall may include identifiers such as a sticker tag, a poster and the name of the shop. The user may use the terminal camera to capture an image. When one or a plurality of identifiers among the identifiers of the sticker tag, the poster and the name of the shop is included in the viewfinder of the camera, the image captured and obtained by the user using the terminal may include an identification object corresponding to one or a plurality of identifiers.

Step 202, receiving navigation information associated with a position of the user in the indoor environment returned from the server.

In the present embodiment, after sending the image captured by the terminal used by the user in the indoor environment to the server in step 201, the server may extract the identification object from the image captured by the terminal used by the user and find out the preset identification object matching the identification object, and may determine the position of the user in the indoor environment based on the preset identification object and the corresponding position of the preset identification object in the indoor environment.

In the present embodiment, when the server extracts the identification object from the image captured by the terminal used by the user, the identification object in the image may be first identified. Then, the feature of the identification object, for example, the SIFT (Scale-Invariant Feature Transform) feature point of the identification object may be acquired, and the identification object is represented by the feature of the identification object, so that the identification object may be extracted from the image captured by the terminal used by the user.

In the present embodiment, the preset identification object and a position in the indoor environment corresponding to the preset identification object may be acquired in advance. For example, when the indoor environment is a mall, the mall has identifiers such as the sticker tag, the poster and the name of the shop. It is possible for the collecting-responsible staff to capture the image in advance using the terminal at the intersection of the mall, the images captured and obtained using the terminal by the collecting-responsible staff at the intersection of the mall may include preset identification objects corresponding to the identifiers at the intersection of the mall. At the same time, the collecting-responsible staff may mark the position in the mall of the identifiers near the intersection of the mall. The terminal used by the collecting-responsible staff may send the images captured at the intersection of the mall and the position in the mall of the identifiers near the intersection of the mall marked by the collecting-responsible staff to the server. The server may extract the identification object from the images captured by the terminal used by the collecting-responsible staff.

The server may store the extracted preset identification object and the position in the mall of the corresponding identifier of the preset identification object marked by the collecting-responsible staff correspondingly. Since the feature of the preset identification object may be used to represent the preset identification object, the storing of the preset identification object may be the storing of the feature of the preset identification object.

When the server extracts the preset identification object from the image captured by the terminal used by the collecting-responsible staff, the preset identification object in the image may be first identified. Then, the feature of the preset identification object, for example, the SIFT feature point of the preset identification object may be acquired, and the preset identification object is represented by the feature of the preset identification object, so that the preset identification object may be extracted from the image captured by the user.

After extracting the identification object from the image captured by the terminal used by the user, the server may find out a preset identification object matching the identification object, from all the preset identification objects extracted from the images captured by the terminal used by the collecting-responsible staff. The extracted feature of the identification object may be matched with the pre-extracted features of all the preset identification objects, to find out preset identification object matching the identification object.

After finding out the preset identification object matching the identification object, the server may further find out a corresponding position of the preset identification object in the mall matching the identification object, which is the position of the identifier in the mall corresponding to the preset identification object pre-marked by the collecting-responsible staff. Then, the position of the user in the mall may be determined based on the corresponding position of the preset identification object in the mall matching the identification object, a proportional relationship between the identification object and the present identification object matching the identification object, and a deflection relationship between the identification object and a shooting angle corresponding to the preset identification object matching the identification object.

For example, an image captured at an intersection of the mall captured by the terminal used by the user contains an identifier-a poster located near the intersection. After receiving the image captured at an intersection of the mall sent from the terminal used by the user, a poster object corresponding to the poster may be extracted from the image captured by the terminal used by the user, such as identifying the poster object in the image captured by the terminal used by the user, acquiring feature of the poster object, identifying the poster object using feature of the poster object and extracting the poster object. The terminal used by the collecting-responsible staff captures the image including the poster object at the intersection in advance, and the collecting-responsible staff marks the position in the mall of the poster. The server may extract the preset identification object, i.e., the poster object in advance from the image captured by the terminal used by the collecting-responsible staff.

The server may store the poster object extracted from the image captured from the terminal used by the collecting-responsible staff correspondingly with the position of the poster in the mall marked by the collecting-responsible staff in advance. Since the feature of the poster object may be used to represent the poster object, the storing of the poster object may be the storing of the feature of the poster object.

After extracting the poster object from the image captured by the terminal used by the user, the server may determine that the feature of the poster extracted from the image captured by the terminal used by the user matches with the feature of the poster image stored in advance by the server. Since the server has stored the position of the poster in the mall corresponding to the poster object marked by the collecting-responsible staff in advance, the position of the poster in the mall may be further determined. After the position of the poster in the mall is determined, the position of the user in the mall may be determined based on the position of the poster in the mall, a proportional relationship between the poster object in the image captured by the terminal used by the user and the poster object in the image captured in advance by the terminal used by the collecting-responsible staff, and a deflection relationship between the poster object in the image captured by the terminal used by the user and a shooting angle corresponding to the poster object in the image captured in advance by the terminal used by the collecting-responsible staff.

In some alternative implementations of the present embodiment, before sending the image captured by the terminal used by the user in the indoor environment to the server, it further comprises: capturing an image in a preset area in the indoor environment to obtain the image including a preset identification object; receiving an input marking instruction for marking a position in the indoor environment corresponding to the preset identification object; and sending the image including the preset identification object, the position in the indoor environment corresponding to the marked preset identification object and the identification of the preset area to the server, causing the server to extract the preset identification object from the image including the preset identification object, and storing the preset identification object, the position in the indoor environment corresponding to the marked preset identification object and the identification of the preset area correspondingly.

In the present embodiment, before sending the image captured by the terminal used by the user in the indoor environment to the server in step 201, it is possible for the collecting-responsible staff to use the terminal to capture the image including the preset identification object in the preset area in the indoor environment, and to input marking instruction to mark the position in the indoor environment corresponding to the preset identification object in the image including the preset identification object, i.e., to mark the position in the indoor environment of the identifier corresponding to the preset identification object. The terminal used by the collecting-responsible staff may send the image including the preset identification object, the marked position in the indoor environment corresponding to the preset identification object and the identification of the preset area to the server.

For example, when the indoor environment is a mall, the preset area may be an area that surrounds a preset area of the intersection in the mall. Each intersection may correspond to a preset area. The preset area may include one or more identifiers. The collecting-responsible staff may use the terminal to capture images in each of the preset areas in the mall in advance and the images may obtain a preset identification object including and corresponding to one or more identifiers in the preset area. At the same time, the collecting-responsible staff may mark the position in the mall of the identifier in the preset area. The server may receive the image including the preset identification object sent from the terminal used by the collecting-responsible staff, the marked position in the indoor environment corresponding to the preset identification object and the identifier of the preset area. The server may extract the preset identification object from the image including the preset identification object, and store the preset identification object, the position in the mall of the identifier corresponding to the preset identification object marked by the collecting-responsible staff and the identifier of the preset area correspondingly.

In the present embodiment, the position of the user in the indoor environment may be determined by the following method: for example, when the indoor environment is a mall, the terminal used by the user may determine an initial position of the user based on a wireless locating method such as the WiFi location, and send the determined initial position of the user to the server. The server may first determine the preset area in which the position of the user in the indoor environment is located based on the initial position sent from the terminal used by the user. The preset area may contain a plurality of identifiers, and the preset identification objects corresponding to the identifiers in the image captured in advance by the terminal used by the collecting-responsible staff in the preset area may also be in plural. The server may store in advance the preset identification object extracted from the image captured in the preset area by the terminal used by the collecting-responsible staff and the position of the identifier in the mall corresponding to the preset identification object marked by the collecting-responsible staff.

The server may find out a preset identification object that matches with the identification object extracted from the image captured by the terminal used by the user from all the preset identification objects extracted from the images captured by the terminals used by the collecting-responsible staff in the preset area, and the position in the mall corresponding to the preset identification object can be found, that is, the position of the identifier in the mall corresponding to the preset identification object marked in advance by the collecting-responsible staff. The position of the user in the mall may be determined based on the position of the identifier in the mall corresponding to the preset identification object, a proportional relationship between the identification object and the present identification object, and a deflection relationship between the identification object and a shooting angle corresponding to the preset identification object.

In the present embodiment, by sending the image captured by the terminal used by the user in the indoor environment to the server in step 201, the server may receive the navigation information returned from the server associated with the position of the user in the indoor environment, after determining the position of the user in the indoor environment and obtaining the navigation information associated with the position of the user in the indoor environment.

In some alternative implementations of the present embodiment, the navigation information comprises: a navigation route of the position of the user in the indoor environment to the building in the indoor environment, distribution information indicating the distribution of the buildings in the indoor environment.

For example, when the indoor environment is a mall, the navigation information may include the navigation route of the position of the user in the indoor environment to the shop in the mall, the distribution information indicating the distribution of the shops in the mall. The distribution information may be a three-dimensional map containing the names and locations of the respective shops in the mall. The navigation route of the position of the user in the indoor environment to the building in the indoor environment in the navigation information may include a plurality of navigation routes between the position of the user in the indoor environment and various shops in the mall.

Step 203, presenting at least a portion of the navigation information in the image by adopting an augmented reality mode.

In the present embodiment, after receiving navigation information associated with the position of the user in the indoor environment returned from the server in step 202, it is possible to present at least a portion of the navigation information in the image captured by the terminal used by the user by adopting the augmented reality (AR) mode. For example, when the indoor environment is a mall, the augmented reality mode may be adopted to present a three-dimensional map containing the names and locations of the respective shops in the mall in the navigation information in a preset position in the image captured by the terminal used by the user. Thus, the navigation information associated with the position of the user in the indoor environment is presented in the real environment, and the navigation effect is enhanced.

In some alternative implementations of the present embodiment, the presenting at least a portion of the navigation information in the image by adopting the augmented reality mode comprises: receiving an input selection instruction, the selection instruction comprises: the identification of the building in the indoor environment to be reached; determining the navigation route of the position of the user in the indoor environment to the position of the building, and presenting the navigation route in the image by adopting the augmented reality mode.

In the present embodiment, the navigation route of the position of the user in the indoor environment to the indoor environment may be presented in the image captured by the terminal used by the user by adopting the augmented reality mode.

For example, when the indoor environment is a mall, the distribution information in the navigation information may be a three-dimensional map. The three-dimensional map may include icons corresponding to names of the respective shops and relative position of the respective shops in the mall. After presenting the three-dimensional map in the image captured by the terminal used by the user in the augmented reality mode, the user may click on the icon of the shop that the user wishes to arrive in the three-dimensional map so that the input selection instruction can be received, the selection instruction including: the icon of the shop that the user wishes to arrive in the three-dimensional map clicked by the user.

The navigation route of the position of the user in the indoor environment to the position of the shop selected by the user in the indoor environment may be determined from the navigation route in the received navigation information, that is, the plurality of navigation routes of the position of the user in the indoor environment to the various shops in the mall. The navigation route between the position of the user in the indoor environment and the position of the shop that the user wishes to arrive in the indoor environment is presented in the image captured by the terminal used by the user in the augmented reality mode. Thus, the navigation route between the position of the user in the indoor environment and the position of the shop that the user wishes to arrive in the indoor environment is presented in the real environment.

In the present embodiment, the operation in the respective steps in the above embodiments may be performed by an APP. For example, when the indoor environment is a mall, the collecting-responsible staff may pre-use the terminal installed with the APP to send the image including the identification object captured at each intersection of the mall to the server and mark the position of the identification object in the mall on the APP, and send the position of the marked identification object in the mall to the server. When the user in the mall needs the navigation, the terminal installed with the APP may be used to send the captured image to the server, read WiFi-located data and send the WiFi-located data as an initial position to the server. The terminal used by the user may present at least a portion of the navigation information in the image captured by the terminal used by the user by adopting the augmented reality mode, and receive the navigation information associated with the position of the user in the mall returned from the server and determined by the server through the APP.

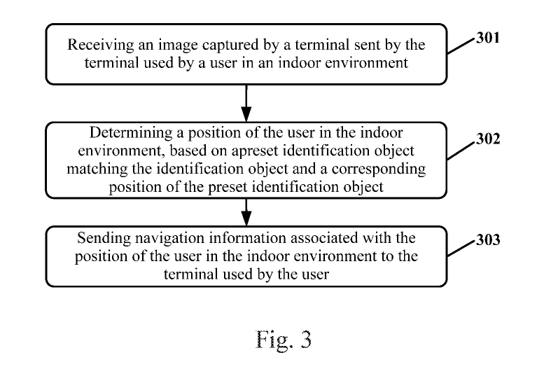

Referring to FIG. 3, a flow of another embodiment of the navigation method according to the present disclosure is shown. The navigation method provided by the embodiment of the present disclosure may be executed by a server such as the server 105 in FIG. 1. The method comprises the following steps:

Step 301, receiving an image captured by a terminal sent by the terminal used by a user in an indoor environment.

For example, when the indoor environment is a mall, there are identifiers in the mall which may easily catch the user's attention in a visual sense. When the user needs navigation in the mall, the user may use the terminal camera to capture an image. When an identifier is contained in the viewfinder of the camera, the obtained captured image may contain an identification object corresponding to the identifier. The mall may include identifiers such as a sticker tag, a poster and an identification of a shop such as the name of the shop. When one or a plurality of identifiers among the identifiers of the sticker tag, the poster and the identification of the shop is included in the viewfinder of the camera, the obtained image comprises an identification object corresponding to one or a plurality of identifiers.

Step 302, determining a position of the user in the indoor environment, based on a preset identification object matching the identification object and a corresponding position of the preset identification object.

In the present embodiment, after receiving the image captured by the terminal sent by the terminal used by the user in the indoor environment in step 301, the identification object may be extracted from the image captured by the terminal used by the user to find out a preset identification object matching the identification object. The position of the user in the indoor environment may be determined based on the preset identification object and the corresponding position of the preset identification object.

In the present embodiment, when the identification object is extracted from the image captured by the terminal used by the user, the identification object in the image may be first identified. Then, the feature of the identification object, for example, the SIFT feature point of the identification object may be acquired, and the identification object is represented by the feature of the identification object, so that the identification object may be extracted from the image captured by the terminal used by the user.

In the present embodiment, the preset identification object and a position in the indoor environment corresponding to the preset identification object may be acquired in advance. For example, when the indoor environment is a mall, the mall has identifiers such as the sticker tag, the poster and the identifier of the shop such as the name of the shop. It is possible for the collecting-responsible staff to capture the image in advance using the terminal at the intersection of the mall, the images captured and obtained using the terminal by the collecting-responsible staff at the intersection of the mall may include preset identification objects corresponding to the identifiers at the intersection of the mall. At the same time, the collecting-responsible staff may mark the position in the mall of the identifiers near the intersection of the mall. After receiving the images captured at the intersection of the mall sent by the terminal used by the collecting-responsible staff and the position in the mall of the identifiers near the intersection of the mall marked by the collecting-responsible staff, the preset identification objects may be extracted from the images captured by the terminal used by the collecting-responsible staff, and the extracted preset identification objects may be stored correspondingly with the position in the mall of the identifiers corresponding to the preset identification objects marked by the collecting-responsible staff. Since the feature of the preset identification object may be used to represent the preset identification object, the storing of the preset identification object may be the storing of the feature of the preset identification object.

When extracting the preset identification object from the image captured by the terminal used by the collecting-responsible staff, the preset identification object in the image may be first identified. Then, the feature of the preset identification object, for example, the SIFT feature point of the preset identification object may be acquired, and the preset identification object is represented by the feature of the preset identification object, so that the preset identification object is extracted from the image captured by the collecting-responsible staff.

After extracting the identification object from the image captured by the terminal used by the user, the server may find out a preset identification object matching the identification object, from all the preset identification objects extracted from the images captured by the terminal used by the collecting-responsible staff. The extracted feature of the identification object may be matched with the pre-extracted features of all the preset identification objects, to find out the preset identification object matching the identification object. After finding out the preset identification object matching the identification object, a corresponding position of the preset identification object in the mall matching the identification object may be further found out, which is the position of the identifier in the mall corresponding to the preset identification object pre-marked by the collecting-responsible staff. Then, the position of the user in the mall may be determined based on the corresponding position of the preset identification object in the mall matching the identification object, a proportional relationship between the identification object and the present identification object matching the identification object, and a deflection relationship between the identification object and a shooting angle corresponding to the preset identification object matching the identification object.

For example, an image captured at an intersection of the mall captured by the terminal used by the user contains an identifier-a poster located near the intersection. After receiving the image captured at an intersection of the mall sent from the terminal used by the user, a poster object corresponding to the poster may be extracted from the image captured by the terminal used by the user, such as identifying the poster object in the image captured by the terminal used by the user, acquiring feature of the poster object, identifying the poster object using the feature of the poster object, and extracting the poster object. The terminal used by the collecting-responsible staff captures the image including the poster object at the intersection in advance, and the collecting-responsible staff marks the position in the mall of the poster. The preset identification object, i.e., the poster object may be extracted in advance from the image captured by the terminal used by the collecting-responsible staff, and the poster object extracted from the image captured by the terminal used by the collecting-responsible staff is stored in advance corresponding to the position in the mall of the poster marked by the collecting-responsible staff. Since the feature of the poster object may be used to represent the poster object, the storing of the poster object may be the storing of the feature of the poster object.

Thus, after extracting the poster object from the image captured by the terminal used by the user, it may be determined that the feature of the poster extracted from the image captured by the terminal used by the user matches with the feature of the poster image stored in advance. Since the position of the poster in the mall corresponding to the poster object marked by the collecting-responsible staff is pre-stored, the position of the poster in the mall may be further determined. After the position of the poster in the mall is determined, the position of the user in the mall may be determined based on the position of the poster in the mall, a proportional relationship between the poster object in the image captured by the terminal used by the user and the poster object in the image captured in advance by the terminal used by the collecting-responsible staff, and a deflection relationship between the poster object in the image captured by the terminal used by the user and a shooting angle corresponding to the poster object in the image captured in advance by the terminal used by the collecting-responsible staff.

In some alternative implementations of the present embodiment, before receiving the image captured and sent by the terminal used by the user in the indoor environment, it further comprises: receiving collected information sent from the terminal, the collected information including: an image including the preset identification object captured in the preset area in the indoor environment by the terminal, the position in the indoor environment corresponding to the marked preset identification object, the identifier of the preset area; extracting the preset identification object from the image including the preset identification object; storing the preset identification object, the corresponding position in the indoor environment of the marked preset identification object and the identifier of the preset area correspondingly.

In the present embodiment, before receiving the image captured and sent by the terminal used by the user in the indoor environment in step 301, it is possible for the collecting-responsible staff to use the terminal to capture the image including the preset identification object in the preset area in the indoor environment, and to mark the position in the indoor environment corresponding to the preset identification object including the preset identification object in the image, i.e., to mark the position of the identifier in the indoor environment corresponding to the preset identification object.

For example, when the indoor environment is a mall, the preset area may be an area that surrounds a preset area of the intersection in the mall. Each intersection may correspond to a preset area. The preset area may include one or more identifiers. The collecting-responsible staff may use the terminal to capture images in each of the preset areas in the mall in advance and the images may obtain a preset identification object including and corresponding to one or more identifiers in the preset area. At the same time, the collecting-responsible staff may mark the position in the mall of the identifier in the preset area. After receiving the image including the preset identification object sent from the terminal used by the collecting-responsible staff, the marked position in the indoor environment corresponding to the preset identification object and the identifier of the preset area, the preset identification object may be extracted from the image including the preset identification object, and the preset identification object, the position in the mall of the identifier corresponding to the preset identification object marked by the collecting-responsible staff and the identifier of the preset area are stored correspondingly.

In the present embodiment, the position of the user in the indoor environment may be determined by the following method: for example, when the indoor environment is a mall, the terminal used by the user may determine an initial position of the user based on a wireless location such as the WiFi location. After receiving the initial position sent by the terminal used by the user, the preset area in which the position of the user in the indoor environment is located, may be determined based on the initial position sent from the terminal used by the user. The preset area may contain a plurality of identifiers, and the preset identification objects corresponding to the identifiers in the image captured in advance by the terminal used by the collecting-responsible staff in the preset area may also be in plural. The preset identification object extracted from the image captured in the preset area by the terminal used by the collecting-responsible staff and the position of the identifier in the mall corresponding to the preset identification object marked by the collecting-responsible staff may be stored in advance.

Then, a preset identification object that matches with the identification object extracted from the image captured by the terminal used by the user may be found out from all the preset identification objects extracted from the images captured by the terminals used by the collecting-responsible staff in the preset area, and the position in the mall corresponding to the preset identification object may be found out, that is, the position of the identifier in the mall corresponding to the preset identification object marked in advance by the collecting-responsible staff. The position of the user in the mall may be determined based on the position of the identifier in the mall corresponding to the preset identification object, a proportional relationship between the identification object and the present identification object, and a deflection relationship between the identification object and a shooting angle corresponding to the preset identification object.

Step 303, sending navigation information associated with the position of the user in the indoor environment to the terminal used by the user.

In the present embodiment, after determining the position of the user in the indoor environment based on the preset identification object matching the identification object and the corresponding position of the preset identification object in the indoor environment in step 302, it is possible to send the navigation information associated with the position of the user in the indoor environment to the terminal. Thus, the terminal used by the user may present the navigation information in the image captured by the terminal used by the user by adopting the augmented reality mode.

In some alternative implementations of the present embodiment, the navigation information comprises: a navigation route of the position of the user in the indoor environment to the building in the indoor environment, distribution information indicating the distribution of the buildings in the indoor environment.

For example, when the indoor environment is a mall, the navigation information may include but is not limited to: the navigation route of the position of the user in the indoor environment to the shop in the mall, the distribution information indicating the distribution of the shops in the mall. The distribution information may be a three-dimensional map. The three-dimensional map may include icons corresponding to names of the respective shops and relative position of the respective shops in the mall.

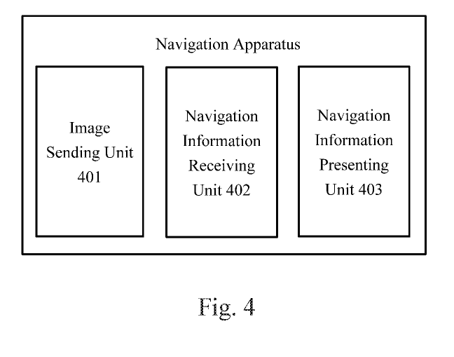

With reference to FIG. 4, as an implementation to the method illustrated in the above figures, the present disclosure provides an embodiment of a navigation apparatus. The apparatus embodiment corresponds to the method embodiment shown in FIG. 2.

As shown in FIG. 4, the navigation apparatus according to the present embodiment comprises: an image sending unit 401, a navigation information receiving unit 402, and a navigation information presenting unit 403. Wherein the image sending unit 401 is configured to send an image captured by a terminal used by a user in an indoor environment to a server, the image including: an identification object. The navigation information receiving unit 402 is configured to receive navigation information associated with a position of the user in the indoor environment returned from the server, the position of the user in the indoor environment being determined by the server based on a preset identification object matching the identification object and a position in the indoor environment corresponding to the preset identification object. The navigation information presenting unit 403 is configured to present at least a portion of the navigation information in the image by adopting an augmented reality mode.

In some alternative implementations of the present embodiment, the identification object comprises at least one of the following: a sticker object, a poster object and a building identification object.

In some alternative implementations of the present embodiment, the navigation information comprises: a navigation route of the position of the user in the indoor environment to the building in the indoor environment, distribution information indicating the distribution of the buildings in the indoor environment.

In some alternative implementations of the present embodiment, the navigation apparatus further comprises: a collection unit (not shown), configured to capture an image in a preset area in the indoor environment to obtain the image including a preset identification object; receive an input marking instruction for marking a position in the indoor environment corresponding to the preset identification object; and send the image including the preset identification object, the position in the indoor environment corresponding to the marked preset identification object and an identification of the preset area to the server, causing the server to extract the preset identification object from the image including the preset identification object, and store the preset identification object, the position in the indoor environment corresponding to the marked preset identification object and the identification of the preset area correspondingly.

In some alternative implementations of the present embodiment, the navigation information presenting unit 403 comprises: a navigation route presenting subunit (not shown), configured to receive an input selection instruction, the selection instruction comprises: an identification of the building in the indoor environment to be reached; determining a navigation route between the position of the user in the indoor environment and the building in the indoor environment to be reached in the navigation route; and presenting the navigation route in the image by adopting the augmented reality mode.

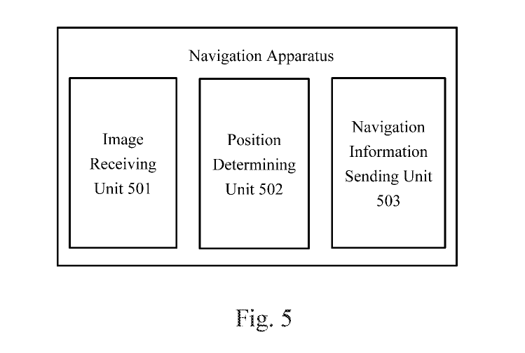

With reference to FIG. 5, as an implementation to the method illustrated in the above figures, the present disclosure provides an embodiment of a navigation apparatus. The apparatus embodiment corresponds to the method embodiment shown in FIG. 3.

As shown in FIG. 5, the navigation apparatus according to the present embodiment comprises: an image receiving unit 501, a position determining unit 502, and a navigation information sending unit 503. Wherein the image receiving unit 501 is configured to receive an image captured by a terminal sent by the terminal used by a user in an indoor environment, the image including: an identification object. The position determining unit 502 is configured to determine a position of the user in the indoor environment, based on a preset identification object matching the identification object and a position in the indoor environment corresponding to the preset identification object. The navigation information sending unit 503 is configured to send navigation information associated with the position to the terminal used by the user, to present at least a portion of the navigation information in the image by adopting an augmented reality mode on the terminal used by the user.

In some alternative implementations of the present embodiment, the navigation apparatus further comprises: a storing unit (not shown), configured to receive collected information sent from the terminal, the collected information including: an image including the preset identification object captured in the preset area in the indoor environment by the terminal, the position in the indoor environment corresponding to the marked preset identification object, the identifier of the preset area; extract the preset identification object from the image including the preset identification object; store the preset identification object, the corresponding position in the indoor environment of the marked preset identification object and the identifier of the preset area correspondingly.

In some alternative implementations of the present embodiment, the position determining unit 502 comprises: a user position determining subunit (not shown), configured to receive an initial position of the user sent by the terminal used by the user, the initial position being determined based on a wireless locating method; determine a preset area in the indoor environment in which the initial position is located; find out the stored preset identification object matching the identification object corresponding to the identification of the preset area and the position in the indoor environment corresponding to the marked identification object; determine the position of the user in the indoor environment based on the position, a proportional relationship between the identification object and the preset identification object, and a deflection relationship between the identification object and a shooting angle corresponding to the preset identification object.

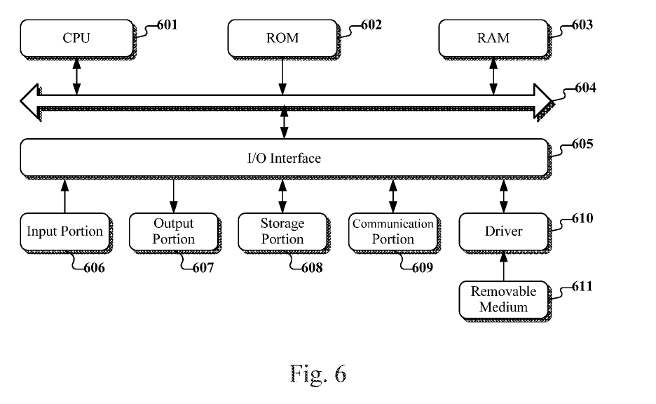

Referring to FIG. 6, a schematic structural diagram of a computer system 600 adapted to implement a server of the embodiments of the present application is shown.

As shown in FIG. 6, the computer system 600 comprises a central processing unit (CPU) 601, which may execute various appropriate actions and processes in accordance with a program stored in a read-only memory (ROM) 602 or a program loaded into a random access memory (RAM) 603 from a storage portion 608. The RAM 603 also stores various programs and data required by operations of the system 600. The CPU 601, the ROM 602 and the RAM 603 are connected to each other through a bus 604. An input/output (I/O) interface 605 is also connected to the bus 604.

The following components are connected to the I/O interface 605: an input portion 606 including a keyboard, a mouse etc.; an output portion 607 comprising a cathode ray tube (CRT), a liquid crystal display device (LCD), a speaker etc.; a storage portion 608 including a hard disk and the like; and a communication portion 609 comprising a network interface card, such as a LAN card and a modem. The communication portion 609 performs communication processes via a network, such as the Internet. A driver 610 is also connected to the I/O interface 605 as required. A removable medium 611, such as a magnetic disk, an optical disk, a magneto-optical disk, and a semiconductor memory, may be installed on the driver 610, to facilitate the retrieval of a computer program from the removable medium 611, and the installation thereof on the storage portion 608 as needed.

In particular, according to an embodiment of the present disclosure, the process described above with reference to the flow chart may be implemented in a computer software program. For example, an embodiment of the present disclosure comprises a computer program product, which comprises a computer program that is tangibly embedded in a machine-readable medium. The computer program comprises program codes for executing the method as illustrated in the flow chart. In such an embodiment, the computer program may be downloaded and installed from a network via the communication portion 609, and/or may be installed from the removable media 611. The computer program, when executed by the central processing unit (CPU) 601, implements the above mentioned functionalities as defined by the methods of the present application.

The flowcharts and block diagrams in the figures illustrate architectures, functions and operations that may be implemented according to the system, the method and the computer program product of the various embodiments of the present invention. In this regard, each block in the flow charts and block diagrams may represent a module, a program segment, or a code portion. The module, the program segment, or the code portion comprises one or more executable instructions for implementing the specified logical function. It should be noted that, in some alternative implementations, the functions denoted by the blocks may occur in a sequence different from the sequences shown in the figures. For example, in practice, two blocks in succession may be executed, depending on the involved functionalities, substantially in parallel, or in a reverse sequence. It should also be noted that, each block in the block diagrams and/or the flow charts and/or a combination of the blocks may be implemented by a dedicated hardware-based system executing specific functions or operations, or by a combination of a dedicated hardware and computer instructions.

In another aspect, the present application further provides a non-volatile computer storage medium. The non-volatile computer storage medium may be the non-volatile computer storage medium included in the apparatus in the above embodiments, or a stand-alone non-volatile computer storage medium which has not been assembled into the apparatus. The non-volatile computer storage medium stores one or more programs. The one or more programs, when executed by a device, cause the device to: sending an image captured by a terminal used by a user in an indoor environment to a server, the image comprising an identification object; receiving navigation information associated with a position of the user in the indoor environment returned from the server, the position being determined by the server based on a preset identification object matching the identification object and a position in the indoor environment corresponding to the preset identification object; and presenting at least a portion of the navigation information in the image by adopting an augmented reality mode.

The foregoing is only a description of the preferred embodiments of the present application and the applied technical principles. It should be appreciated by those skilled in the art that the inventive scope of the present application is not limited to the technical solutions formed by the particular combinations of the above technical features. The inventive scope should also cover other technical solutions formed by any combinations of the above technical features or equivalent features thereof without departing from the concept of the invention, such as, technical solutions formed by replacing the features as disclosed in the present application with (but not limited to), technical features with similar functions.

What is claimed is:

1. A navigation method, comprising:
sending an image captured by a terminal used by a user in an indoor environment to a server, the image comprising an identification object;
receiving navigation information associated with a position of the user in the indoor environment returned from the server, the position being determined by the server based on a preset identification object matching the identification object and a position in the indoor environment corresponding to the preset identification object; and
presenting at least a portion of the navigation information in the image by adopting an augmented reality mode.

2. The method according to claim 1, wherein the identification object comprises at least one of the following: a sticker object, a poster object and a building identification object.

3. The method according to claim 2, wherein the navigation information comprises: a navigation route from the position of the user in the indoor environment to the building in the indoor environment, distribution information indicating distribution of the buildings in the indoor environment.

4. The method according to claim 3, before the sending an image captured by a terminal used by a user in an indoor environment to a server, the method further comprising:
capturing an image in a preset area in the indoor environment to obtain the image including a preset identification object;
receiving an input marking instruction for marking a position in the indoor environment corresponding to the preset identification object; and
sending the image including the preset identification object, the position in the indoor environment corresponding to the marked preset identification object and the identification of the preset area to the server, causing the server to extract the preset identification object from the image including the preset identification object, and storing correspondingly the preset identification object, the position in the indoor environment corresponding to the marked preset identification object and the identification of the preset area.

5. The method according to claim 4, wherein the presenting at least a portion of the navigation information in the image by adopting an augmented reality mode comprises:
receiving an input selection instruction, the selection instruction comprising an identification of the building in the indoor environment to be reached;
determining a navigation route between the position of the user in the indoor environment and the building in the indoor environment to be reached in the navigation route; and
presenting the navigation route in the image by adopting the augmented reality mode.

6. A navigation method, comprising:
receiving an image captured by a terminal sent by the terminal used by a user in an indoor environment, the image comprising an identification object;
determining a position of the user in the indoor environment, based on a preset identification object matching the identification object and a position in the indoor environment corresponding to the preset identification object; and
sending navigation information associated with the position to the terminal used by the user, to present at least a portion of the navigation information in the image by adopting an augmented reality mode on the terminal used by the user.

7. The method according to claim 6, before the receiving the image captured and sent by the terminal used by the user in the indoor environment, the method further comprising:
receiving collected information sent from the terminal, the collected information comprising an image including the preset identification object captured in the preset area in the indoor environment by the terminal, the position in the indoor environment corresponding to the marked preset identification object, and the identifier of the preset area;
extracting the preset identification object from the image including the preset identification object; and
storing correspondingly the preset identification object, the corresponding position in the indoor environment of the marked preset identification object, and the identifier of the preset area.

8. The method according to claim 7, wherein the determining a position of the user in the indoor environment, based on a preset identification object matching the identification object and a position in the indoor environment corresponding to the preset identification object, comprises:
receiving an initial position of the user sent by the terminal used by the user, the initial position being determined based on a wireless locating method;
determining a preset area in the indoor environment in which the initial position is located;
finding out the stored preset identification object matching the identification object corresponding to the identification of the preset area and the position in the indoor environment corresponding to the marked identification object; and
determining the position of the user in the indoor environment based on the position, a proportional relationship between the identification object and the preset identification object, and a deflection relationship between the identification object and a shooting angle corresponding to the preset identification object.

9. A navigation apparatus, the apparatus comprising:
at least one processor; and
a memory storing instructions, which when executed by the at least one processor, cause the at least one processor to perform operations, the operations comprising:
sending an image captured by a terminal used by a user in an indoor environment to a server, the image comprising an identification object;
receiving navigation information associated with a position of the user in the indoor environment returned from the server, the position being determined by the server based on a preset identification object matching the identification object and a position in the indoor environment corresponding to the preset identification object; and
presenting at least a portion of the navigation information in the image by adopting an augmented reality mode.

10. The apparatus according to claim 9, wherein the identification object comprises at least one of the following: a sticker object, a poster object and a building identification object.

11. The apparatus according to claim 10, wherein the navigation information comprises: a navigation route from the position of the user in the indoor environment to the building in the indoor environment, distribution information indicating distribution of the buildings in the indoor environment.

12. The apparatus according to claim 11, wherein the operations further comprises:
capturing an image in a preset area in the indoor environment to obtain the image including a preset identification object; receiving an input marking instruction for marking a position in the indoor environment corresponding to the preset identification object; and
sending the image including the preset identification object, the position in the indoor environment corresponding to the marked preset identification object and an identification of the preset area to the server, causing the server to extract the preset identification object from the image including the preset identification object, and storing correspondingly the preset identification object, the position in the indoor environment corresponding to the marked preset identification object and the identification of the preset area.

13. The apparatus according to claim 12, wherein the presenting at least a portion of the navigation information in the image by adopting an augmented reality mode comprises:
receiving an input selection instruction, the selection instruction comprising an identification of the building in the indoor environment to be reached;
determining a navigation route between the position of the user in the indoor environment and the building in the indoor environment to be reached in the navigation route; and
presenting the navigation route in the image by adopting the augmented reality mode.

14. A navigation apparatus, the apparatus comprising:
at least one processor; and
a memory storing instructions, which when executed by the at least one processor, cause the at least one processor to perform operations, the operations comprising:
receiving an image captured by a terminal sent by the terminal used by a user in an indoor environment, the image comprising an identification object;
determining a position of the user in the indoor environment, based on a preset identification object matching the identification object and a position in the indoor environment corresponding to the preset identification object; and
sending navigation information associated with the position to the terminal used by the user, to present at least a portion of the navigation information in the image by adopting an augmented reality mode on the terminal used by the user.

15. The apparatus according to claim 14, wherein the operations further comprises:
receiving collected information sent from the terminal, the collected information comprising an image including the preset identification object captured in the preset area in the indoor environment by the terminal, the position in the indoor environment corresponding to the marked preset identification object, and the identifier of the preset area;
extracting the preset identification object from the image including the preset identification object; and
storing correspondingly the preset identification object, the corresponding position in the indoor environment of the marked preset identification object and the identifier of the preset area.

16. The apparatus according to claim 15, wherein the determining a position of the user in the indoor environment, based on a preset identification object matching the identification object and a position in the indoor environment corresponding to the preset identification object, comprises:
receiving an initial position of the user sent by the terminal used by the user, the initial position being determined based on a wireless locating method;
determining a preset area in the indoor environment in which the initial position is located;
finding out the stored preset identification object matching the identification object corresponding to the identification of the preset area and the position in the indoor environment corresponding to the marked identification object; and
determining the position of the user in the indoor environment based on the position, a proportional relationship between the identification object and the preset identification object, and a deflection relationship between the identification object and a shooting angle corresponding to the preset identification object.

17. A non-transitory computer storage medium storing a computer program, which when executed by one or more processors, cause the one or more processors to perform operations, the operations comprising:
sending an image captured by a terminal used by a user in an indoor environment to a server, the image comprising an identification object;
receiving navigation information associated with a position of the user in the indoor environment returned from the server, the position being determined by the server based on a preset identification object matching the identification object and a position in the indoor environment corresponding to the preset identification object; and
presenting at least a portion of the navigation information in the image by adopting an augmented reality mode.

18. A non-transitory computer storage medium storing a computer program, which when executed by one or more processors, cause the one or more processors to perform operations, the operations comprising:
receiving an image captured by a terminal sent by the terminal used by a user in an indoor environment, the image comprising an identification object;
determining a position of the user in the indoor environment, based on a preset identification object matching the identification object and a position in the indoor environment corresponding to the preset identification object; and
sending navigation information associated with the position to the terminal used by the user, to present at least a portion of the navigation information in the image by adopting an augmented reality mode on the terminal used by the user.
